(19) United States
(12) Patent Application Publication
(10) Pub. No.: US 2013/0062291 A1
(43) Pub. Date: Mar. 14, 2013

(54) Re-Entrainment Reduction Structure For Fluid Filter Assembly

(71) Applicants: David Elliot Hackett, Washington, IL (US); Chad Falah Ahmad, Peoria, IL (US)

(72) Inventors: David Elliot Hackett, Washington, IL (US); Chad Falah Ahmad, Peoria, IL (US)

(73) Assignee: CATERPILLAR INC., Peoria, IL (US)

(21) Appl. No.: 13/229,837

(22) Filed: Sep. 12, 2011

(51) Int. Cl. B01D 37/00; B01D 35/00

(52) U.S. Cl. 210/767; 210/348

(57) ABSTRACT

A fluid filter assembly includes a housing oriented along a vertical axis. A filter medium is disposed within the housing, oriented along the vertical axis, and has a filtration rating. The filter medium traps particulates having a particulate size greater than the filtration rating. A particulate containment space is located below the filter medium relative to the vertical axis and is defined by an inner surface of the housing and a lower end of the filter medium. A re-entrainment reduction structure, having an array of hollow cells, is positioned within the particulate containment space for receiving dislodged particulates.

### TECHNICAL FIELD

The present disclosure relates generally to a fluid filter assembly, and more particularly to a re-entrainment reduction structure for reducing re-entrainment of particulates into a fluid flow within the fluid filter assembly.

### BACKGROUND

A fluid filter, such as a liquid or gas filter, typically includes a filter medium for removing impurities or solid particulates from a fluid as it passes through the filter. Internal combustion engines, in particular, use numerous fluid filters, including fuel filters for removing contaminants from the fuel to reduce damage to components of the fuel system that may be caused by the contaminants. Typically, a fuel filter comprises a housing having a filter medium, such as filter paper, disposed therein. Fuel flows through the filter medium to remove particulates and other contaminants upstream from the engine to avoid potential damage and clogging of the engine components. Although there is little difference in the overall function, fluid filters may vary in design and filtering means. For example, diesel fuel filters are often configured to collect water in an area where it can be easily removed from the filter.

The filter medium usually has a filtration rating representing the filtering capabilities of the medium. For example, the filter medium may be configured to trap particulates larger than the filtration rating. These particulates that become trapped within the filter medium may become dislodged, such as when fuel flow is reduced or when the filter experiences significant vibrations. These dislodged particulates may migrate to the bottom of the housing gravity and settle on the housing floor, only to be re-entrained into the fuel flow when the fuel flow resumes. As a result, the filter medium must again attempt to trap the large particulates, potentially leading to an overall reduction in efficiency of the fluid filter.

U.S. Pat. No. 4,740,299 to Popoff et al. teaches a filter assembly with a threaded collection bowl. The collection bowl and filter assembly use a self-sealing o-ring and threaded mating arrangement in order to withstand high pressure differentials. The collection bowl, according to one embodiment, may define an inner collection zone and an outer collection zone, with the inner collection zone receiving pre-filtered particulates for a radially outward flow design and the outer collection zone receiving pre-filtered particulates for a radially inward flow design. Thus, only one of the inner and outer collection zones is used to collect pre-filtered particulates. Although the Popoff reference appears to disclose a collection area for particulates, it does not teach any means for reducing re-entrainment of the collected particulates.

The present disclosure is directed to one or more of the problems set forth above.

### SUMMARY OF THE DISCLOSURE

In one aspect, a fluid filter assembly includes a housing oriented along a vertical axis. A filter medium is disposed within the housing, oriented along the vertical axis, and has a filtration rating. The filter medium traps particulates having a particulate size greater than the filtration rating. A particulate containment space is located below the filter medium relative to the vertical axis and is defined by an inner surface of the housing and a lower end of the filter medium. A re-entrainment reduction structure, having an array of hollow cells, is positioned within the particulate containment space for receiving dislodged particulates.

In another aspect, a method of reducing re-entrainment of particulates in a fluid filter assembly includes entraining particulates into a fluid flow through the fluid filter assembly. The particulates are trapped within the filter medium and then dislodged from the filter medium. The particulates migrate downward relative to a vertical axis of the fluid filter assembly and into hollow cells of a re-entrainment reduction structure using gravity. Re-entrainment of the particulates into the fluid flow is reduced, at least in part, by shielding the particulates from the fluid flow using axial walls separating the hollow cells.

In yet another aspect, a re-entrainment reduction structure for a fluid filter assembly includes a unitary structure having an array of hollow cells separated by axial walls which extend substantially parallel to a vertical axis of the fluid filter assembly. A periphery of the unitary structure defines a housing contact surface and has a diameter matching an inner diameter of the housing at the particulate containment space. The unitary structure includes a plurality of pedestals extending axially beyond top edges of the axial walls and having distal ends defining filter contact surfaces for contacting lower ends of a filter medium disposed within the fluid filter assembly. Bottom edges of at least a portion of the axial walls define a housing floor contact surface. When the unitary structure is positioned within the particulate containment space, the hollow cells receive dislodged particulates.

### BRIEF DESCRIPTION OF THE DRAWINGS

FIG. 1 is a schematic of an engine system including a fluid filter assembly, according to the present disclosure;

FIG. 2 is an exploded perspective view of an exemplary fluid filter assembly, according to one aspect of the present disclosure;

FIG. 3 is a perspective view of the fluid filter assembly of FIG. 2, with the housing shown in phantom to reveal the internal components of the assembled fluid filter assembly, according to another aspect of the present disclosure;

FIG. 4 is a perspective view of an exemplary re-entrainment reduction structure, according to another aspect of the present disclosure;

FIG. 5 is a perspective view of an alternative embodiment of a re-entrainment reduction structure, according to another aspect of the present disclosure; and

FIG. 6 is a cross sectional view of another exemplary fluid filter assembly including another alternative embodiment of a re-entrainment reduction structure, according to another aspect of the present disclosure.

### DETAILED DESCRIPTION

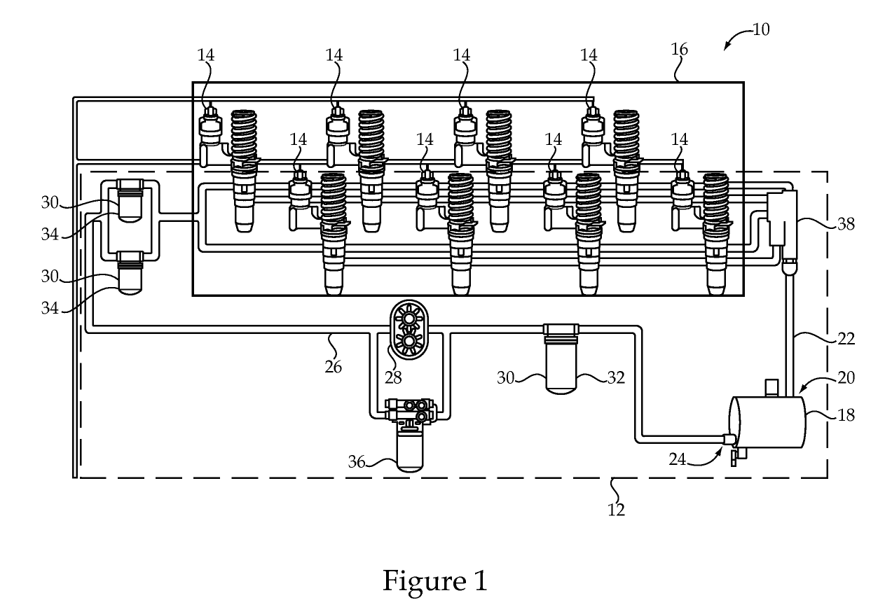

An exemplary embodiment of an internal combustion engine 10 with an attached fuel system 12 is shown generally in FIG. 1. The internal combustion engine 10, which may be a compression ignition engine, comprises a plurality of fuel injectors 14, as is known in the art, and also includes an engine housing 16 to which the fuel system 12 is attached. The fuel system 12 generally includes a fuel tank 18 having an inlet 20 in fluid communication with a fuel return line 22, and an outlet 24 in fluid communication with a fuel supply line 26. A fuel transfer pump 28 may be positioned along the fuel supply line 26 for drawing low pressure fuel from the fuel tank 18 to pressurize and circulate the fuel to the plurality of fuel injectors 14. One or more fuel filters 30 may be positioned along the fuel supply line 26 for filtering particulates and other contaminants from the fuel. For example, a primary fuel filter 32 may be provided upstream from the fuel transfer pump 28, and one or more secondary fuel filters 34 may be provided downstream from the fuel transfer pump 28. As should be appreciated, the internal combustion engine 10 and fuel system 12 may include additional components and systems, including, but not limited to a priming pump 36 and a pressure regulator 38.

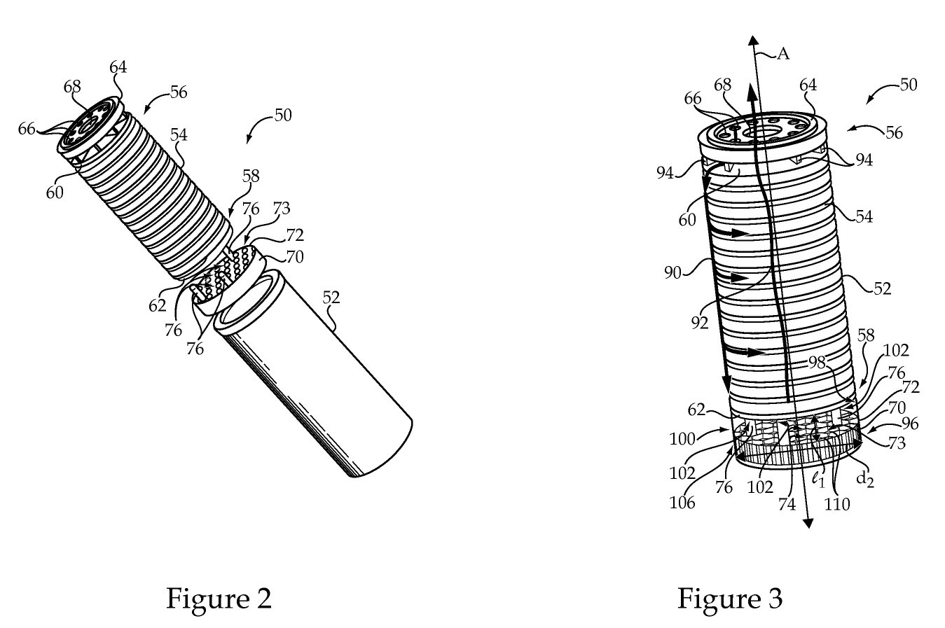

Turning now to FIG. 2, an exemplary embodiment of a fluid filter assembly that may be used with the internal combustion engine 10 and fuel system 12 of FIG. 1 is shown generally at 50. The fluid filter assembly 50, which may be substituted for fuel filters 30 of FIG. 1, may generally include a hollow cylindrical housing 52, which defines a hollow chamber therein. A filter medium 54, which may also have a cylindrical shape, is disposed within the housing 52 and comprises any medium suitable for separating contaminants. The filter medium 54 may be supported at opposing ends 56 and 58 by an upper end cap 60 and lower end cap 62, respectively. A base plate 64, which may be sealingly attached to the housing 52, may include a plurality of inlet ports 66 and a central outlet port 68. The fluid filter assembly 50 also includes a re-entrainment reduction structure, an exemplary embodiment of which is shown at 70. The re-entrainment reduction structure 70, which will be discussed later in greater detail, generally includes a unitary structure 72 having an array 73 of hollow cells 74 for receiving particulates. The re-entrainment reduction structure 70 may also include a plurality of pedestals 76 extending axially from the unitary structure 72.

In one non-limiting example, the outlet port 68 may have a plurality of threads formed therein to facilitate rotatable mounting of the fluid filter assembly 50. According to the exemplary embodiment, the fluid filter assembly 50 may be attached to the engine housing 16 of FIG. 1, or at another suitable location, as dictated by the particular engine 10 and fuel system 12 configuration. However, the fluid filter assembly 50 may be used in any of a variety of fluid systems and, thus, may be positioned as appropriate for the particular application. It should be appreciated that the filter medium 54 may have a filtration rating representing the filtering capabilities of the medium 54. For example, the filter medium 54 may be configured to trap particulates larger than the filtration rating. According to the exemplary embodiment, it may be desirable to utilize fluid filter assemblies 50 having different filtration capabilities at different positions along the fuel supply line 26. Although a specific embodiment is shown, it should be appreciated that the fluid filter assembly 50 may include additional components and may have alternative configurations. According to one example, the fluid filter assembly 50 may also include a center tube, having passages therethrough, to supportively reinforce the filter medium 54 thereon.

Turning now to FIG. 3, the fluid filter assembly 50 is shown in an assembled configuration, with the housing 52 shown in phantom to reveal the internal components of the filter assembly 50. According to an installed configuration, the housing 52, filter medium 54, and re-entrainment reduction structure 70 may all be substantially oriented along a vertical axis A. When the fluid filter assembly 50 is assembled and installed, the filter medium 54 and housing 52 define outer peripheral fluid passages 90 and a central fluid passage 92. Specifically, according to a particular embodiment, the fluid flows through the inlet ports 66 of the base plate 64, is distributed along peripheral fluid passages 90 using radial ribs 94, and flows radially inward through the filter medium 54, where a percentage of particulates may be removed. The filtered fluid then flows along the central fluid passage 92 and exits the fluid filter assembly 50 through the central outlet port 68.

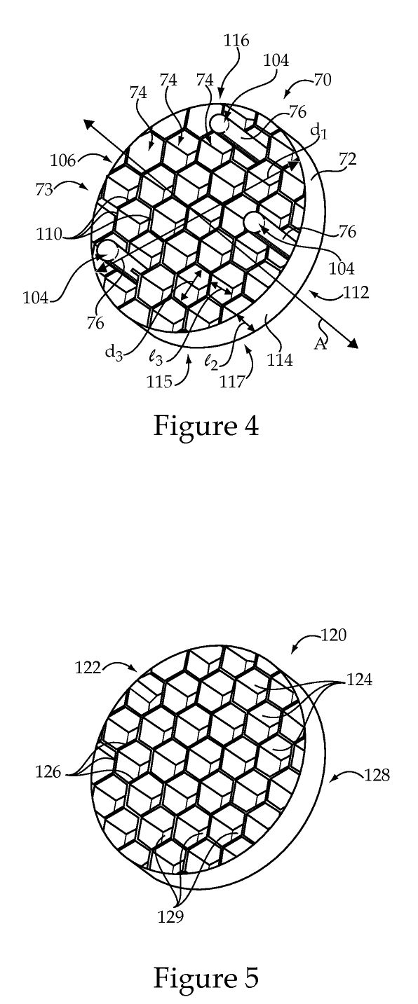

According to the exemplary embodiment, the fluid filter assembly 50 also includes a particulate containment space 96 located below the filter medium 54 relative to the vertical axis A. Specifically, the particulate containment space 96 is defined by an inner surface 98 of the housing 52 and the lower end 58 of the filter medium 54. The re-entrainment reduction structure 70 is positioned within the particulate containment space 96. A particulate distribution space 100 is located within the particulate containment space 96 between the re-entrainment reduction structure 70 and the lower end 58 of the filter medium 54. The particulate distribution space 100 spans an axial distance l₁ greater than zero and, thus, represents a volume, which may be varied based on the particular application. The plurality of pedestals 76 extend axially beyond top edges 106 of axial walls 110, which separate the hollow cells 74, into the particulate distribution space 100, with distal ends 102 of the pedestals 76 defining filter contact surfaces 104 (FIG. 4) for contacting the lower end 58 of the filter medium 54. As such, the pedestals 76 may assist in maintaining a desired volume of the particulate distribution space 100.

With reference also to FIG. 4, the re-entrainment reduction structure 70 will be discussed in greater detail. As stated above, the re-entrainment reduction structure 70 comprises the unitary structure 72 having the array 73 of hollow cells 74 separated by axial walls 110 which may extend substantially parallel to the vertical axis A. A periphery 112 of the re-entrainment reduction structure 70 defines a housing contact surface 114 having a round cross section and defining a diameter d₁ matching an inner diameter d₂ of the housing 52 at the particulate containment space 96. It should be appreciated that “matching,” as used herein, means that the diameter d₁ defined by the housing contact surface 114 is sized such that the re-entrainment reduction structure 70 may be received within the housing 52. It should also be appreciated that, depending on the diameter d₁ of the re-entrainment reduction structure 70 and the amount of clearance between the re-entrainment structure 70 and the inner surface 98 of the housing 52, the unitary structure 72, at least at the periphery 112 thereof, may have an axial height sufficient to prevent tilting of the re-entrainment reduction structure 70 relative to the vertical axis A. Bottom edges 115 of the axial walls 110 may define housing floor contact surfaces 117 for contacting a floor of the housing, shown below.

The axial walls 110 may have similar axial heights or different axial heights. According to some embodiments, the periphery 112, which may or may not be defined by the axial walls 110, may have an axial height l₂ greater than an axial height l₃ of the internal cells 74. Alternatively, or additionally, the axial height l₂, l₃ of the axial walls 110 may be greater than a maximum diameter d₃ of each of the hollow cells 74. According to the exemplary embodiment, the axial walls 110 may define a hexagonal lattice 116. However, it should be appreciated that the hollow cells 74 may be any shape and/or size, and the array 73 may include any pattern or arrangement. For example, the array 73 may include any number of hollow cells 74 that are square, circular, arcuate, or otherwise. According to some embodiments, it may be desired to select an arrangement of hollow cells 74 that provides a maximum number of partitions that function to isolate the particulates. It may also be desirable to provide minimal surface area at the top of the re-entrainment reduction structure 70 that is substantially perpendicular to the vertical axis A to reduce the amount of particulates that may collect on the top edges 106 of the axial walls 110. Thus, it should be appreciated that the design and dimensions of the re-entrainment reduction structure 70 may vary to provide desired results in various applications.

An alternative re-entrainment reduction structure 120 is shown in FIG. 5. As shown, the alternative re-entrainment reduction structure 120 may be similar to the re-entrainment reduction structure 70 described above. Specifically, for example, the alternative re-entrainment reduction structure 120 may also include an array 122 of hollow cells 124 defined by axial walls 126. However, the hollow cells 124 of structure 120 may be closed at lower ends 128 thereof. Thus, according to the alternative embodiment, bottom walls 129 of the hollow cells 124 may collect particulates, rather than allowing particulates to pass through. Although only minor variations are shown in the alternative embodiment of FIG. 5, it should be appreciated, as stated above, that alternative re-entrainment reduction structures may vary not only in cell configuration, but also in the shape, size, number, and pattern of cells provided. Further, various fluid filter configurations may favor different re-entrainment reduction structure configurations.

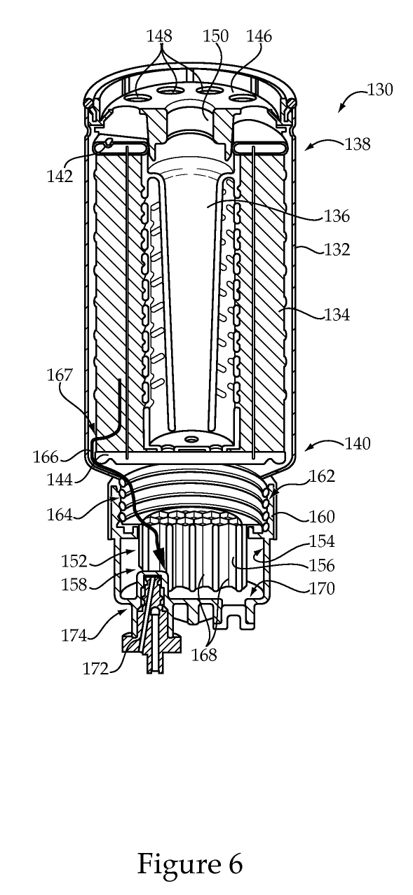

Turning now to FIG. 6, an alternative fluid filter assembly is shown generally at 130. The fluid filter assembly 130 may be similar to fluid filter assembly 50 described above. Namely, the fluid filter assembly 130 may include a cylindrical housing 132 having a cylindrical filter medium 134 disposed therein and supported by a center tube 136. The filter medium 134 may be supported at opposing ends 138 and 140 by an upper end cap 142 and a lower end cap 144, which may be substantially solid and, thus, prevent the passage of fluid and/or particulates through the lower end cap 144. A base plate 146 may include a plurality of inlet ports 148 and a central outlet port 150. The fluid filter assembly 130 also includes a particulate containment space 152 located below the filter medium 134 and defined by an inner surface 154 of the housing 132 and the lower end 140 of the filter medium 134. A re-entrainment reduction structure 156, which may have similarities to the re-entrainment reduction structures 70 and 120 described above, may be positioned within the particulate containment space 152.

According to the embodiment of FIG. 6, the particulate containment space 152 or, rather, the inner surface 154 of the housing 132 and the lower end 140 of the filter medium 134 may define a water collection space 158. Specifically, the particulate containment space 152 and water collection space 158 may define a separable, or removable, portion 160 of the housing 132. As shown, the separable portion 160 may be secured to the housing 132 through a threaded engagement 162. The re-entrainment reduction structure 156 may also include a particulate distribution space 164 located within the particulate containment space 152 between the re-entrainment reduction structure 156 and the lower end 140 of the filter medium 134. According to the particular embodiment, the pedestals 76 described above may be unnecessary.

Particulates, which may include dislodged particulates, may follow a particulate path 166 that includes passing the particulates exclusively through an annular channel 167 defined by the inner surface 154 of the housing 132 and the end cap 144. Next, the particulates may pass through hollow cells 168 of the re-entrainment reduction structure 156, where they may settle on a floor 170 of the housing 132 or, more specifically, the separable portion 160. Alternatively, according to a re-entrainment reduction structure having closed cells, such as the alternative re-entrainment reduction structure 120 of FIG. 5, the particulates may settle within closed cells. According to some embodiments, the fluid filter assembly 130 may also include a water and particulate removal valve 172 coupled with an opening 174 through the floor 170, through which water and/or particulates may be removed, as is known in the art.

### INDUSTRIAL APPLICABILITY

Referring generally to FIGS. 1-6, operation of a fluid system, such as fuel system 12, including the removal of contaminants from a fluid flow using the fluid filter assemblies 50 and 130 described herein will be described. For ease of explanation, an exemplary fluid system operation will be described with specific reference to the fluid filter assembly 50 of FIGS. 2 and 3. However, it should be appreciated that the fluid filter assembly 130 of FIG. 6 may provide similar functionality, as described herein. Generally, particulates may be entrained into the fluid flow upstream from the fluid filter assembly 50. Within the fluid filter assembly 50, the fluid first flows through the inlet ports 66 of the base plate 64 and along peripheral fuel passages 90. The fluid then flows radially inward through the filter medium 54, where a percentage of particulates may be trapped within the filter medium 54. The filtered fluid may then flow along the central fuel passage 92 and exit the fluid filter assembly 50 through the central outlet port 68.

According to a specific example, such as within the context of fuel system 12, fuel flow may be reduced, such as, for example, when the internal combustion engine 10 is stopped. When the fuel flow is reduced, or when significant vibrations occur, the particulates may become dislodged from the filter medium 54. The dislodged particulates may then migrate downward into a particulate containment space 96 and into the hollow cells 74 of the re-entrainment reduction structure 70 using gravity. This may include passing the particulates exclusively through an annular channel 167 (shown in FIG. 6) and into a particulate distribution space 100. Within the particulate distribution space 100, a turbulent fluid flow, created and/or enhanced using radial ribs 94, may distribute the particulates among the hollow cells 74. The particulates may then settle on a housing floor 170 (shown in FIG. 6) or, according to embodiments utilizing closed cells, such as the embodiment of FIG. 5, the particulates may settle within closed hollow cells.

When the internal combustion engine 10 is again started, or flow is otherwise increased, re-entrainment of the particulates into the fluid flow may be reduced, at least in part, by shielding the particulates from the fluid flow using axial walls 110 separating the hollow cells 74. Specifically, the hollow cells 74 may capture the particulates and isolate those particulates from the turbulent fluid flow within the filter housing 52. The captured particulates, along with any water, may be removed from the fluid filter assembly 50 by using a water and particulate removal valve, such as valve 172 of FIG. 6.

The re-entrainment reduction structure described herein provides an efficient and effective means for improving the efficiency of a fluid filter, particularly fluid filters that experience re-entrainment of dislodged particulates. Any of the various embodiments of the re-entrainment reduction structure may be permanent or removable and, further, may be provided as a retrofit to some existing fluid filters. Specific configurations of the re-entrainment reduction structures may vary depending on the particular applications, with all embodiments reducing re-entrainment of dislodged particulates by providing a structure for capturing and isolating the dislodged particulates from the fluid flow.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A fluid filter assembly, comprising:
a housing oriented along a vertical axis;
a filter medium disposed within the housing, oriented along the vertical axis, and having a filtration rating, wherein the filter medium traps particulates having a particulate size greater than the filtration rating;
a particulate containment space located below the filter medium relative to the vertical axis and defined by an inner surface of the housing and a lower end of the filter medium; and
a re-entrainment reduction structure positioned within the particulate containment space and having an array of hollow cells for receiving dislodged particulates.

2. The fluid filter assembly of claim 1, further including a particulate distribution space located within the particulate containment space between the re-entrainment reduction structure and the lower end of the filter medium, wherein the particulate distribution space spans an axial distance greater than zero.

3. The fluid filter assembly of claim 2, wherein the re-entrainment reduction structure includes a plurality of pedestals extending axially into the particulate distribution space, wherein distal ends of the pedestals define filter contact surfaces for contacting the lower end of the filter medium.

4. The fluid filter assembly of claim 1, wherein a periphery of the re-entrainment reduction structure defines a housing contact surface having a round cross section and defining a diameter matching an inner diameter of the housing at the particulate containment space.

5. The fluid filter assembly of claim 4, wherein the hollow cells are separated by axial walls which extend substantially parallel to the vertical axis.

6. The fluid filter assembly of claim 5, wherein the axial walls define a hexagonal lattice.

7. The fluid filter assembly of claim 5, wherein the hollow cells are closed at lower ends thereof.

8. The fluid filter assembly of claim 5, wherein the inner surface of the housing and the lower end of the filter medium define a water collection space.

9. The fluid filter assembly of claim 8, further including a water and particulate removal valve coupled with an opening through a lower end of the housing.

10. A method of reducing re-entrainment of particulates in a fluid filter assembly, the fluid filter assembly comprising a housing oriented along a vertical axis, a filter medium disposed within the housing, oriented along the vertical axis, and having a filtration rating, wherein the filter medium traps particulates having a particulate size greater than the filtration rating, a particulate containment space located below the filter medium relative to the vertical axis and defined by an inner surface of the housing and a lower end of the filter medium, and a re-entrainment reduction structure positioned within the particulate containment space and having an array of hollow cells, the method comprising steps of:
entraining the particulates into a fluid flow through the fluid filter assembly;
trapping the particulates within the filter medium;
dislodging the particulates from the filter medium;
migrating the particulates downward relative to the vertical axis and into the hollow cells of the re-entrainment reduction structure using gravity; and
reducing re-entrainment of the particulates into the fluid flow, at least in part, by shielding the particulates from the fluid flow using axial walls separating the hollow cells.

11. The method of claim 10, further including reducing the fluid flow prior to the dislodging step, and increasing the fluid flow prior to the step of reducing re-entrainment of the particulates.

12. The method of claim 10, further including flowing fluid radially inward through the filter medium.

13. The method of claim 12, wherein the migrating step includes passing the particulates exclusively through an annular channel defined by the inner surface of the housing and an end cap supporting the lower end of the filter medium.

14. The method of claim 13, wherein the migrating step further includes distributing the particulates among the hollow cells by moving the particulates through a particulate distribution space located within the particulate containment space between the re-entrainment reduction structure and the lower end of the filter medium.

15. The method of claim 11, further including settling the particulates on a floor of the housing subsequent to the migrating step.

16. The method of claim 15, further including draining the particulates from the fluid filter assembly using a water and particulate removal valve coupled to an opening through the floor.

17. The method of claim 11, further including settling the particulates within closed hollow cells of the re-entrainment reduction structure.

18. A re-entrainment reduction structure for a fluid filter assembly, the fluid filter assembly comprising a housing oriented along a vertical axis, a filter medium disposed within the housing, oriented along the vertical axis, and having a filtration rating, wherein the filter medium traps particulates having a particulate size greater than the filtration rating, and a particulate containment space located below the filter medium relative to the vertical axis and defined by an inner surface of the housing and a lower end of the filter medium, the re-entrainment reduction structure comprising:
a unitary structure having an array of hollow cells separated by axial walls which extend substantially parallel to the vertical axis, wherein a periphery of the unitary structure defines a housing contact surface;
wherein a diameter of the periphery matches an inner diameter of the housing at the particulate containment space;
wherein the unitary structure includes a plurality of pedestals extending axially beyond top edges of the axial walls, wherein distal ends of the pedestals define filter contact surfaces for contacting the lower end of the filter medium;
wherein bottom edges of, at least a portion of, the axial walls define a housing floor contact surface;
wherein, when the unitary structure is positioned within the particulate containment space, the hollow cells receive dislodged particulates.

19. The re-entrainment reduction structure of claim 18, wherein the axial walls define a hexagonal lattice.

20. The re-entrainment reduction structure of claim 18, wherein the axial walls have a height greater than a maximum diameter of each of the hollow cells.
